(19) United States
(12) Patent Application Publication
(10) Pub. No.: US 2007/0081020 A1
(43) Pub. Date: Apr. 12, 2007

(54) Printhead service station

(76) Inventor: Jin-Sheng Lai, Hsi Chih City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/246,211

(22) Filed: Oct. 11, 2005

(51) Int. Cl. B41J 2/165

(52) U.S. Cl. 347/36

(57) ABSTRACT

A printhead service station that is arranged on one side of a print track of a printer for cleaning and covering the printhead, comprising a bottom part, a transmission part, and a base, wherein a frame is disposed across the top surface of the bottom part, provided with a plurality of openings and a cap for covering the printhead, wherein said transmission part is connected pivot-movably to the bottom part to support the printhead, and is provided with a moving device and a resilient device to move the transmission part over the bottom part, and wherein said base is also pivot-movably connected to the bottom part, is provided with a plurality of cleaning devices and a ripple track, said base is provided further with a pulling-and-holding device such that, when the transmission part is moved on the track, said base can displace up and down beneath the bottom part, and allows said cleaning devices shuttle upwardly and downwardly within the opening of the bottom part, respectively.

### BACKGROUND OF THE INVENTION

1. Field of the Invention

The present invention relates to a printhead service station, and particularly to a printhead service station characterized in that it can clean and cover the printhead without a power source, has a simple structure, can be easily assembled, and is suitable for using by a variety of ink-jet printer structures.

2. Description of the Prior Art

In the peripheral equipments of the computer or the print industries, the printer have become already an essential fundamental equipment, which, in addition to print documents, assignments, and reports, as progressing with color ink-jet techniques, the inkjet printer can produce desirable colors by spraying color with different concentration on a same position by means of ink cartridges with different colors. Therefore, it is not a dream to produce a print with a same quality level as a photograph by using a printer. For the printing industry, a ink-jet product is a worldwide trend, an inkjet printer can be applied for jet-printing timely a small amount of diverse products, and finished quickly, saving time and operations for making a color separating screen, that create more advantages in the competitive age.

In the use of a inkjet printer, after printing with the printhead for a period of time, the nozzle may have residual ink and dust that can affect the print quality, and after used, if the printhead leaves uncovered, the nozzle might be dried easily and hence jam the printhead. Therefore, in the design of the internal structure of current inkjet printer, a printhead service station is provided, with its main object and function to clean the printhead for maintaining the print quality and to cover the printhead after used, so as to keep the printhead moist without being dried and jammed.

However, the design of current printhead service station mostly utilize an external power source for driving the cleaning wiper and the protection cover of the printhead service station, such that, when the printhead entering the printhead service station, by using the external power source to drive the cleaning wiper to perform the actions of scraping and cleaning, and to drive the protection cover to cover the printhead; accordingly, since the design of the entire structure needs the conjunction of a power circuit, the volume and the cost thereof cannot be reduced efficiently.

Further, in the conventional printhead service station, as the printhead enters the station, the cleaning wiper and the protection cover are apt to interfere with each other, and even the base plate body of the printhead is easily damaged by the cleaning wiper; thus there is a need to improve the design of the entire structure.

### SUMMARY OF THE INVENTION

The main objective of the present invention is to provide a printhead service station characterized in that it has a simple structure, is easily assembled, and can clean and cover the printhead without needing a power source.

For achieving the above objective, a printhead service station of the present invention comprises a bottom part, a transmission part, and a base, wherein said bottom part comprises two mutual-engaged plate bodies, and has an open space formed at the top and the bottom surfaces thereof, and a frame provided across the top surface thereof, wherein said frame is provided with a plurality of equally spaced openings, and the frame is provided with a cap on both sides of each opening for covering the printhead, respectively; wherein said transmission part is movably and pivotally connected to the above mentioned bottom part to support the printhead, and comprises two oppositely arranged holders and a baffle connected across said two holders, wherein a multiple set of moving devices is provided on the two holders so that the transmission part can move on the bottom part, and wherein a resilient device is connected further between the transmission part and the bottom part for returning the moved transmission part; wherein said base includes two symmetrical lateral plate bodies and a plurality of cleaning devices arranged across the two lateral plate bodies, wherein a track with ripple profile is provided oppositely on the top of the two lateral plate bodies, and further a pulling-and-holding device is connected between said two lateral plate bodies and the bottom part in a manner that, when one of the above-described moving devices of the transmission part moving on the ripple track, said base can displace up and down beneath the bottom part by the pulling-and-holding device, and causes a plurality of the cleaning devices shuttling up and down in the plurality of openings arranged in the above-described bottom part, respectively.

For further understand of the present invention, by way of the following preferred embodiments, in conjunction with drawings and numerals, the disclosure of the present invention and effects achieved are described in detail as following.

### BRIEF DESCRIPTION OF THE DRAWINGS

FIG. 1 shows a three-dimensional external exploded view of a printhead service station according to an embodiment of the present invention.

FIG. 2 shows a three-dimensional external view of a bottom part according to an embodiment of the present invention.

FIG. 3 shows a three-dimensional external view of a printhead service station of the present invention after assembled.

FIG. 4 shows a partial cross-sectional schematic view of the combined bottom part and the base according to an embodiment of the present invention.

FIG. 5 shows a partial cross-sectional schematic view showing the situation as the printhead enters/leaves the printhead service station according to an embodiment of the present invention wherein.

FIG. 6 is a schematic view showing the state of the cleaning device and the cap when the printhead enters the printhead service station according to an embodiment of the present invention, showing.

FIG. 7 is a schematic view showing the use state of the actions of the printhead entering the printhead service station and of the cleaning device according to an embodiment of the present invention.

FIG. 8 is a schematic view showing the use state of the actions of the printhead leaving rightward from the printhead service station and of the cleaning device according to an embodiment of the present invention; and

FIG. 9 is a schematic view showing the state of the printhead descending after used and combined with the cap according to an embodiment of the present invention.

### DETAILED DESCRIPTION OF THE PREFERRED EMBODIMENT

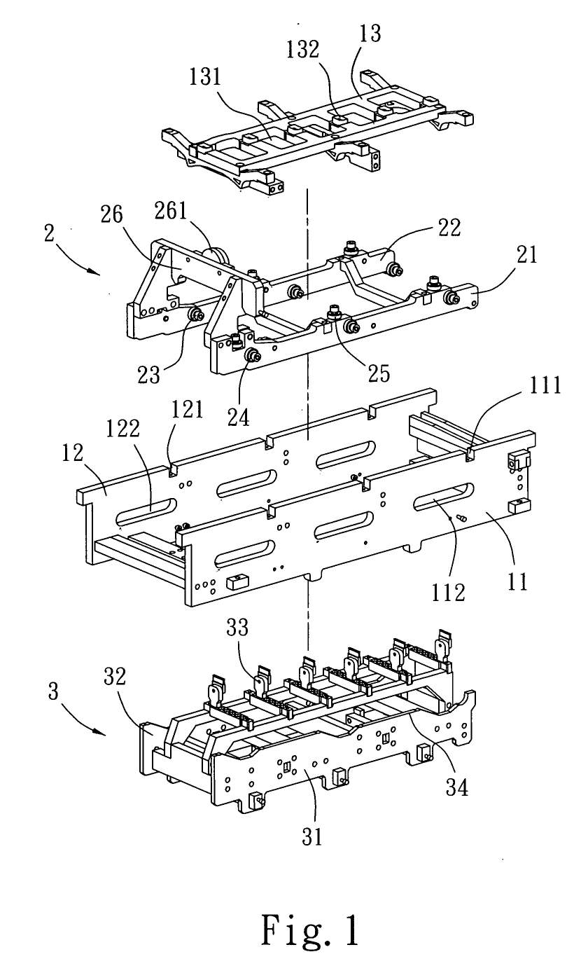

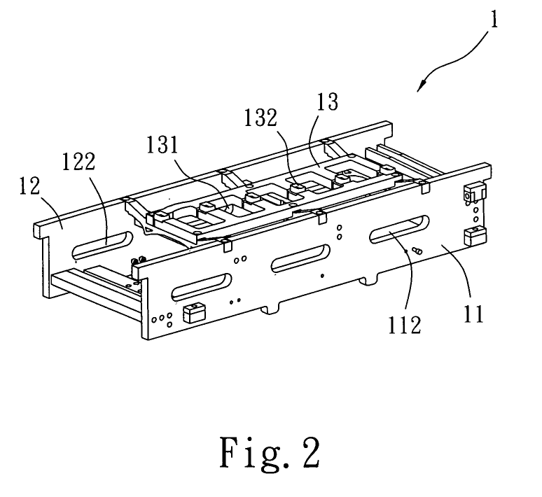

Referring to FIG. 1-5, a printhead service station according to an embodiment of the present invention comprises a bottom part 1, a transmission part 2, and a base 3.

The bottom part 1 comprises two mutual-engaged plate bodies 11 and 12, and has an open space formed at the top and the bottom surfaces thereof, the tops of the two plate bodies 11, 12 of the bottom part 1 are provided with engaging troughs 111 and 121 for fixing a frame 13 across thereon, wherein said frame 13 is provided with a plurality of equally spaced openings 131, and the frame 13 is provided with a cap 132 for covering the printhead 4 on two sides of each opening 131, respectively, and wherein further a plurality of oppositely spaced elongated notches 112 and 122, are provided on the two plate bodies 11 and 12 of the bottom part 1.

The transmission part 2 is movably and pivotally connected to the above mentioned bottom part 1 to support the printhead 4, and comprises two oppositely arranged holders 21 and 22 and a baffle 26 connected across the two holders 21 [symbol] 22, wherein a resilient pad 261 is provided on the baffle 26 for receiving the pushing force of the printhead 4, wherein three moving devices 23, 24, and 25 are provided on the two holders 21 and 22, arranged on the inner side, outer side and the top of the two holders 21 and 22 respectively, wherein the moving device 23 at the inner side is a high-low arrangement, the moving device 24 at the outer side of the two holders 21 and 22 is configured to be accommodated in the elongated notches 112 and 122 of the two plate bodies 11 and 12 of the bottom part 1 in a manner that the transmission part 2 can move on the bottom part 1, wherein said the moving device 25 arranged on the top of the two holders 21 and 22 is tightly attached against the inner side of the two plate bodies 11 and 12 of the bottom part 1; and wherein a resilient device 5 is connected further between the transmission part 2 and the bottom part 1 for returning the moved transmission part 2.

The base 3 includes two symmetrical lateral plate bodies 31 and 32 and a plurality of cleaning devices 33 arranged across the two lateral plate bodies 31 and 32, wherein a track 34 with ripple profile is oppositely provided on the top of the two lateral plate bodies 31 and 32 for the above-described moving device 23 arranged at the inner side of the two holders 21 and 22 moving thereon, and further a plurality of pulling-and-holding devices 6 are connected between the two lateral plate bodies 31 and 32 and the bottom part 1, in a manner that when the above-described moving device 23 arranged at the inner side of the two holders 21 and 22 moving on the ripple track 34, the base 3 can be displaced up and down beneath the bottom part 1 by means of the pulling-and-holding device 6, and causes said plurality of the cleaning devices 33 being shuttled up and down in the plurality of openings 131 arranged in the above bottom part 1, respectively.

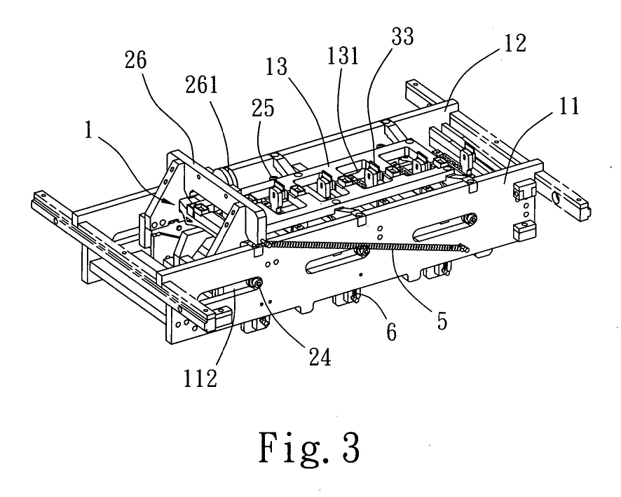

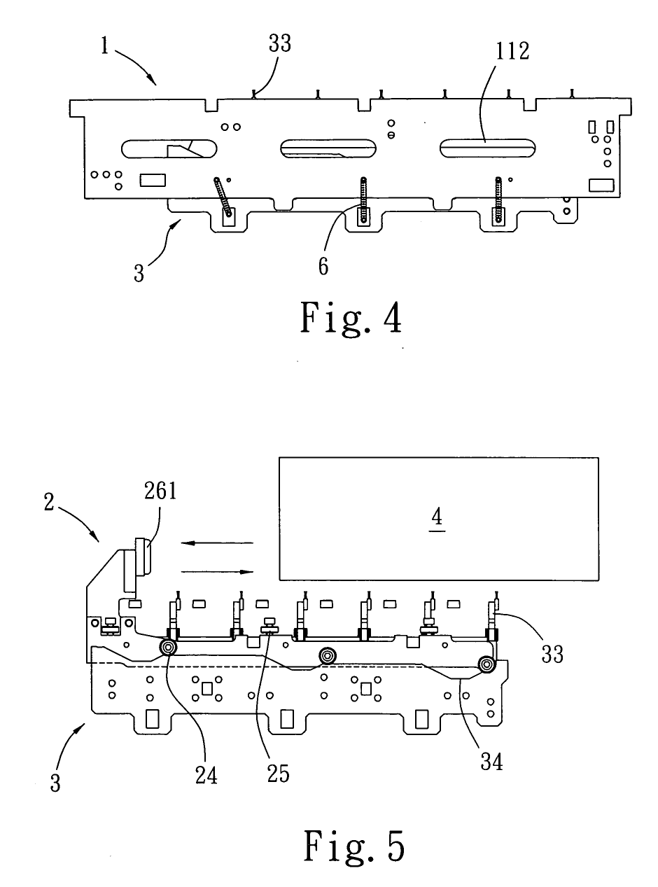

Referring to FIGS. 3 and 4 again, the moving devices 23, 24, and 25 of the present invention can be rollers, while both the resilient device 5 and the pulling-and-holding device 6 can be extension springs, the plurality of the cleaning devices 33 are wipers. Thus when assembled, as shown in FIG. 1 to 5, the transmission part 2 is disposed first from the top of the bottom part 1, and the plurality of moving devices 24 (i.e., roller) on the outer side of the transmission part 2 are inserted into the plurality of elongated notches 112 and 122 of the two plate bodies 11 and 12 of the bottom part 1 in a manner that the movement of the moving device 24 (i.e., roller) can be limited within the elongated notches 112 and 122, while the plurality of moving device 25 (i.e., roller) on the top of the transmission part 2 can be attached just against the two plate bodies 11 and 12 of the bottom part 1, and then the frame 13 is fixed across the engaging troughs 111 and 121 on the top of the two plate bodies 11 and 12 of the bottom part 1, and finally the resilient device 5 (i.e., spring) is connected between the bottom part 1 and the transmission part 2 respectively, and thus completes the combination of the bottom part 1 and the transmission part 2.

After the bottom part 1 and the transmission part 2 assembled, the base 3 is disposed from the lower side of the bottom part 1, and the plurality of pulling-and-holding devices 6 (i.e., extension spring) are connected between the two lateral plate bodies 31 and 32 of the base 3 and the bottom part 1, in a manner that when the moving device 23 arranged in the inner side of the two holders 21 and 22 of the transmission part 2 within the bottom part 1 is situated at the climax of track 34 on the top of two lateral plate bodies 31 and 32 of the base 3, said plurality of pulling-and-holding devices 6 (i.e., extension spring) are in an extended state.

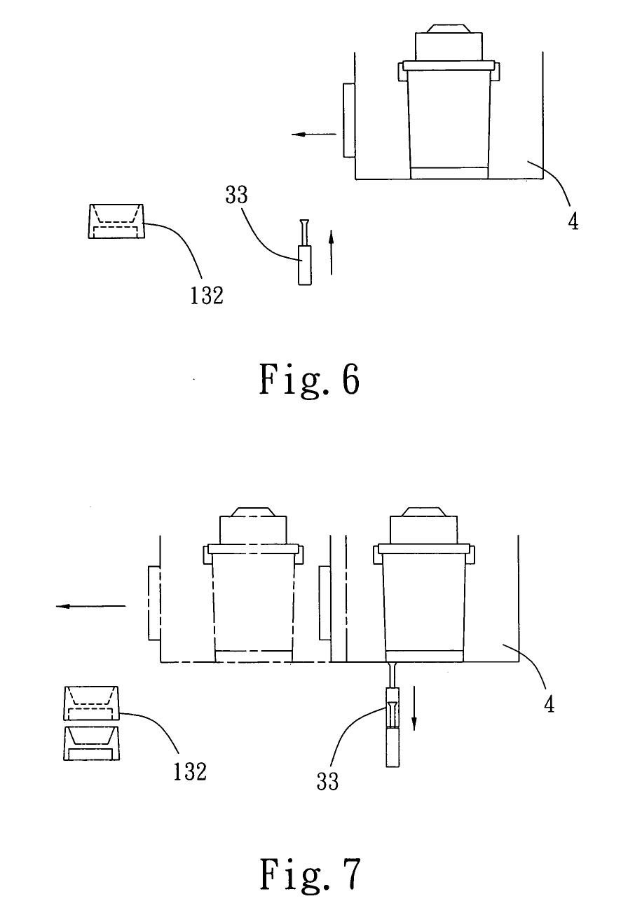

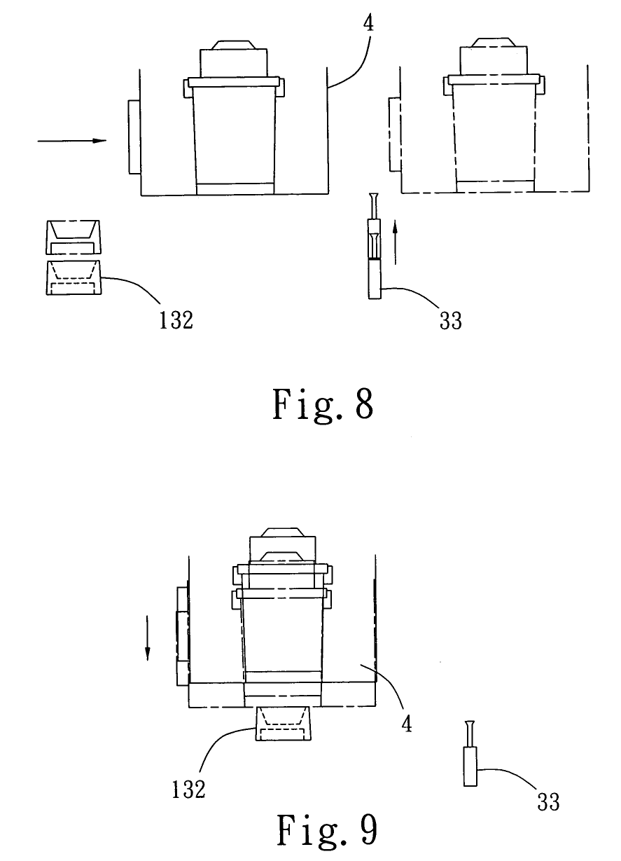

Thus, when bringing into practice actually, as shown in FIG. 3-9, when the printhead 4 entering the printhead service station of the present invention, the printhead 4 can contact directly with the resilient pad 261 of the baffle 26 of the transmission part 2, and pushing the transmission part 2 to leftward move the moving devices 23, 24, and 25 on the inner side, outer side, and the top of the transmission part 2, respectively, and at the same time, the resilient device 5 (i.e., extension spring) connected between the bottom part 1 and the transmission part 2 is extended, and while the moving device 23 (i.e., roller) on the inner side of the transmission part 2 moving, since the track 34 is in ripple, the plurality of pulling-and-holding devices 6 (i.e., extension spring) connected with the base 3 and the bottom part 1 can produce the actions of retraction and extension repeatedly, making the moving device 23 (i.e., roller) to move as walking on the track 34, which, in effect, is the displacement of the base 3 up and down beneath the bottom part 1, and as a result, the plurality of cleaning device 33 (i.e., wipers) above the base 3 can form the up and down shuttle within the plurality of openings 131 of the frame 13 above the bottom part 1.

Consequently, when the printhead 4 entered and pushed the transmission part 2 (see FIG. 3-9), as it passing over the opening 131, the moving device 23 (i.e., roller) on the inner side of the transmission part 2 is just on the lowest point of the track 34 of the base 3, causing the plurality of the pulling-and-holding device 6 having been extended can be returned to the retraction state to displace the base 3 upwardly, that make the plurality of the cleaning devices 33 (i.e., wipers) being just able to scrape and clean the printhead 4. When the printhead 4 leaves the service station after cleaning and proceeds further printing, the transmission part 2 that is pushed previously by the printhead 4 and makes the resilient device 5 (i.e., extension spring) extended, will leave due to the moving rightward of the printhead 4, such that the resilient device 5 can be retracted to restore, and further can drive the transmission part 2 to return back to the state before the printhead 4 entering the service station.

At the end of printing, the printhead 4 will enter the service station, and, after cleaning, descends automatically to the frame 13, on the cap 132 of both sides of each opening 131 and is covered by the cap 132.

As described above, in the printhead service station of the present invention, a bottom part 1, a transmission part 2, and a base 3 are connected via a multiple set of moving devices 23, 24, and 25, as well as springs, and the push force of the printhead 4 itself is used to push the transmission part 2 to achieve the purposes of cleaning the printhead 4, and is characterized in that it exhibits a complete mechanically successive motions without any external electrical power, has a simple design of the overall structure, is easy to assemble and disassemble, and can reduce effectively the cost and the volume of the entire structure.

In summary, according to the description and drawings disclosed above, the present invention can surely achieve the intended purposes of this invention and provides a printhead service station. The above description relates to embodiments and technical means applied according to the present invention, various variations and modifications can be derived according to the disclosure herein and the teaching disclosed, any equivalent change made according to the concept of the present invention without its effect being departing from the spirit covered by the specification and drawings are intended to be considered within the technical scope of the present invention.

What is claimed is:

1. A printhead service station to be arranged on one side of a print track of a printer for cleaning and covering the printhead, comprising:
a bottom part, comprising two mutual-engaged plate bodies with an open space formed at top and bottom surfaces thereof, wherein a frame is provided across the top thereof, and said frame is provided with a plurality of equally spaced openings on the frame, as well as is provided with a cap on two sides of each opening, respectively, for covering said printhead;
a transmission part, being movably and pivotally connected to the above-mentioned bottom part to support the printhead, and comprising two oppositely arranged holders and a baffle across the two holders, wherein a multiple set of moving devices is provided on the two holders in a manner that said transmission part can move on the bottom part, and wherein a resilient device is further connected between the transmission part and the bottom part for returning the moved transmission part; and
a base, comprising two symmetrical lateral plate bodies and a plurality of cleaning devices arranged across the two lateral plate bodies, wherein a track with ripple profile is oppositely provided on the top of the two lateral plate bodies, and further a plurality of pulling-and-holding device is connected between the two lateral plate bodies and the bottom part, thereby when one of the above moving devices of the transmission part moves on the ripple track, said base can displace up and down beneath the bottom part by means of the pulling-and-holding device, and causes a plurality of the cleaning devices being shuttled up and down in the plurality of openings arranged in the above bottom part, respectively.

2. A printhead service station of claim 1, wherein said transmission part has 3 sets of the moving devices which are disposed in the inner side, the outer side, and the top of the two holders, respectively.

3. A printhead service station of claim 2, wherein a plurality of elongated notches are provided, oppositely and spaced separately, on the two plate bodies of said bottom part to accommodate the moving device on the outer side of the two holders and allow them to move therein.

4. A printhead service station of claim 2, wherein the moving device on the inner side of said two holders is provided for moving along the top of the ripple track on the two lateral plate bodies of the base, and said moving device is disposed at high and low positions on the inner side of the two holders.

5. A printhead service station of claim 2, wherein the moving device on the top surface of the two holders is attached tightly against the inner side of the two plate bodies of the bottom part.

6. A printhead service station of claim 1, wherein said moving device is a roller.

7. A printhead service station of claim 1, wherein engaging troughs are provided on the top of the two plate bodies of said bottom part for fixing the frame across thereon.

8. A printhead service station of claim 1, wherein said resilient device and said pulling-and-holding device are extension spring, respectively.

9. A printhead service station of claim 1, wherein said plurality of cleaning devices are wipers.

10. A printhead service station of claim 1, wherein a resilient pad is provided on the baffle connected across the two holders of the transmission part for receiving the push force of the printhead.
